(19) United States
(12) Patent Application Publication
(10) Pub. No.: US 2002/0148933 A1
(43) Pub. Date: Oct. 17, 2002

(54) Cushion pad

(76) Inventor: Meng-Chieh Lin, Feng-Yuan City (TW)

Correspondence Address: Hart, Baxley, Daniels & Holton, Fifth Floor, 59 John Street, New York, NY, 10038, US

(21) Appl. No.: 09/829,632

(22) Filed: Apr. 11, 2001

(51) Int. Cl. B68G 5/00

(52) U.S. Cl. 248/118; 248/918

(57) ABSTRACT

A cushion pad includes a stuff item covered by a surface member and the stuff item is supported on a stiff board. The surface member is connected to the stiff board along a top surface around the stuff item and a circumferential surface of the stiff board. A bottom member is connected to an underside of the stiff board and the surface member not covering the stuff item.

### FIELD OF THE INVENTION

The present invention relates to a cushion pad having a stiff board adhered with a surface member along a top surface of the stiff board, and a stuff item received between the stiff board and the surface member.

### BACKGROUND OF THE INVENTION

A conventional cushion pad for providing cushion feature for users' hands when using keyboards or computer mouse generally comprises a top cover and a lower cover and a PU stuff received in between the top cover and the lower cover. The PU stuff is soft and is adhered between the top cover and the lower cover. However, the PU tends to become a permanent deformation of a recess on the top where the user's hand puts, and the PU could be pressed to expand radially to break the connection portion between the top cover and the lower cover. FIG. 1 shows a latest cushion pad and comprises a cover surface 10 with a first layer 11 adhered to an underside of the cover surface 10. A bladder including a bladder member 12 and a stuff member 13 is sandwiched between the first layer 11 and a second layer 14. The stuff member 13 can be liquid, fabric or the like. The bladder is also be compressed and expands outward to peel the second layer 14 from the first layer 11. As shown in FIG. 2, when manufacturing the cushion pad as shown in FIG. 1, the cover surface 10, the first layer 11, the bladder are put in a recess of a mold 15 and the recess faces upward, and the second layer 14 is then adhered to the bladder and the first layer 11. However, because the bladder is soft so that it is squeezed and trembled when the second layer 14 is accumulated on the bladder. This often makes the second layer 14 to be formed with a protrusion on a central portion of the second layer 14. In other words, the second layer is not a flat surface.

### SUMMARY OF THE INVENTION

In accordance with one aspect of the present invention, there is provided a cushion pad and comprises a surface member and a stuff item covered by the surface member. The stuff item is supported on a stiff board and the surface member is connected to the stiff board along a top surface around the stuff item. A bottom member is connected to an underside of the stiff board and the surface member.

The primary object of the present invention is to provide a cushion pad that includes a stiff board to ensure the bottom member has a flat surface.

Another object of the present invention is to provide a cushion pad that the stuff item is supported on a stiff board and an adhesive layer securely connects the surface member, the stuff item and the stiff board.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional cushion pad;

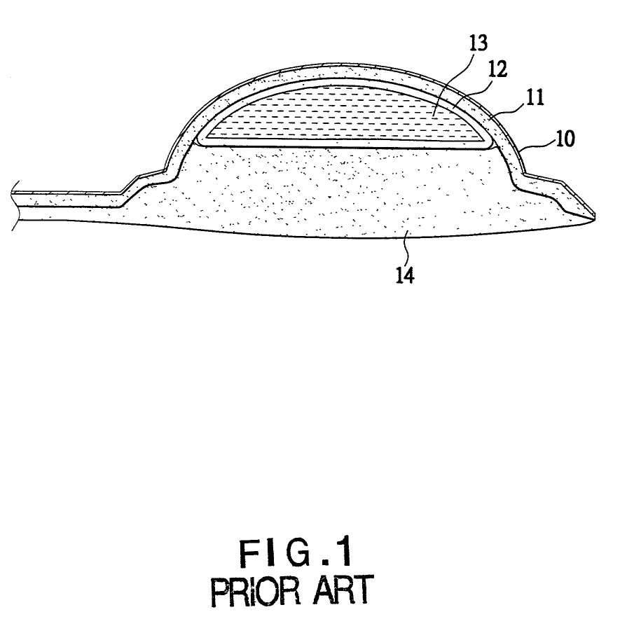

FIG. 2 is a cross sectional view to show the cover surface, the first layer, and the bladder of the conventional cushion pad are put in a recess of a mold, and a second layer is connected to the bladder;

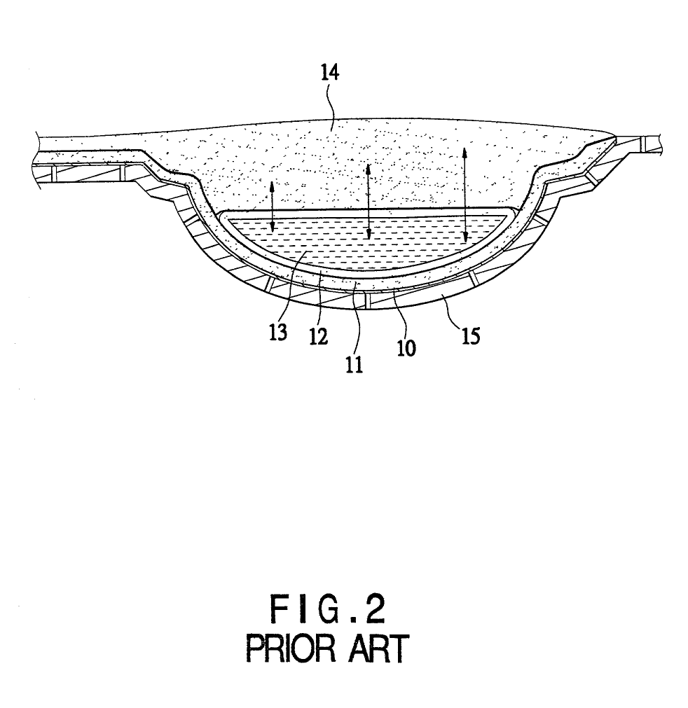

FIG. 3 is a cross sectional view to show a cushion pad of the present invention;

FIG. 4 is a cross sectional view to show the cushion pad of the present invention is put in a mold when the bottom member is to be connected to the cushion pad, and

FIG. 5 is a perspective view to show a fabric is connected to the cushion pad of the present invention.

### DETAILED DESCRIPTION OF THE PREFERRED EMBODIMENT

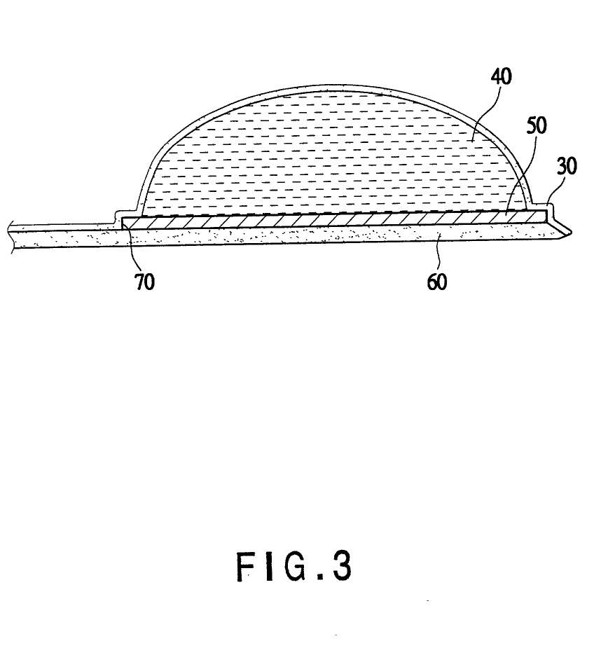

Referring to FIG. 3, the cushion pad of the present invention comprises a surface member 30 and a stuff item 40 is covered by the surface member 30. The stuff item 40 is supported on a stiff board 50 and the surface member 30 connected to the stiff board 50 along a top surface around the stuff item 40 and a circumferential surface of the stiff board 50 by an adhesive later 70. The adhesive layer 70 is located between an underside of the surface member 30 and the top surface of the stiff board 50 around the stuff item 40 and the circumferential surface of the stiff board 50. It is to be noted that the area that the stuff item 40 contacts the top surface of the stiff board 50 is less than the whole top surface of the stiff board 50 so that there is a surface around the stuff item 40 on the stiff board 50 for the surface member 30 to be connected thereon. The material for the surface member 30 is EVA which air is not permeable. The material for the stiff board 50 can be wood, metals, paper boards, PVC, EVA, Acrylic.

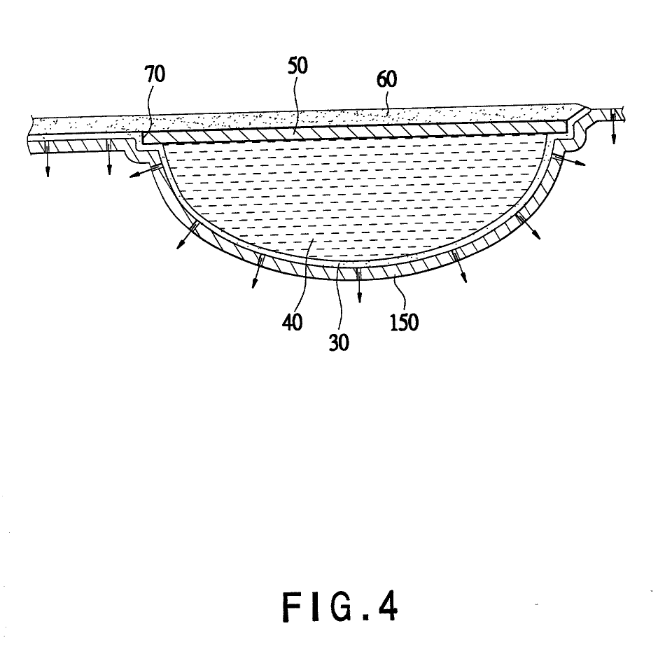

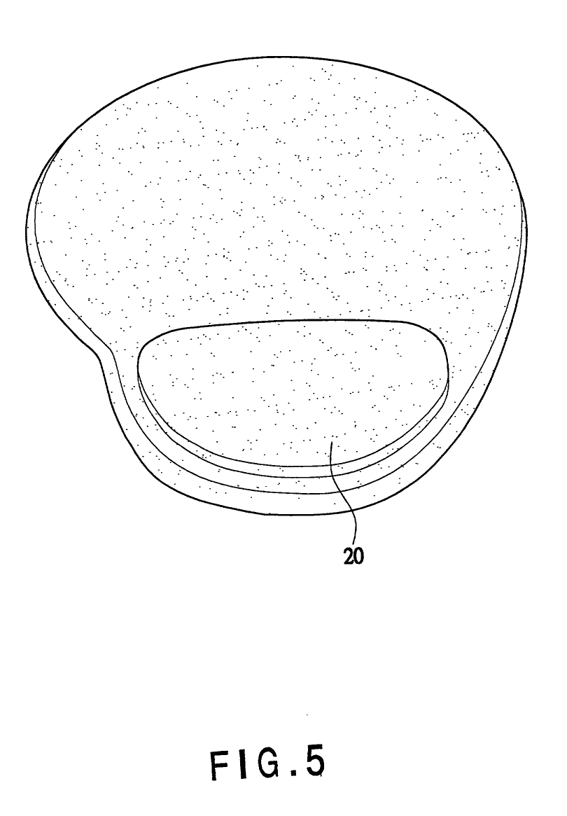

As shown in FIG. 4, a mold 150 has recess in which the surface member 30, the stuff item 40 and the stiff board 50 is received and the stiff board 50 provides a flat surface facing upward. A bottom member 60 is connected to the flat surface of the stiff board 50 and the surface member 30 that does not cover the stuff item 40 is also connected to the bottom member 60. The material for the bottom member 60 can be PU, EVA, PVC, rubber or resin. As shown in FIG. 5, a top layer 20 can be connected to the cushion pad.

While we have shown and described various embodiments in accordance with the present invention, it should be clear to those skilled in the art that further embodiments may be made without departing from the scope of the present invention.

What is claimed is:

1. A cushion pad comprising:
a surface member;
a stuff item covered by said surface member and supported on a stiff board, said surface member connected to said stiff board along a top surface around said stuff item, and
a bottom member connected to an underside of said stiff board and said surface member.

2. The cushion pad as claimed in claim 1 wherein said surface member is connected to said stiff board along a top surface around said stuff item and a circumferential surface of said stiff board.

3. The cushion pad as claimed in claim 2 further comprising an adhesive layer located between an underside of said surface member and said top surface of said stiff board around said stuff item and said circumferential surface of said stiff board.
